(19) United States
(12) Patent Application Publication
(10) Pub. No.: US 2014/0133856 A1
(43) Pub. Date: May 15, 2014

(54) Multiple Downstream Modulation Profiles for Ethernet Passive Optical Network over Coax (EPoC)

(71) Applicant: Broadcom Corporation, Irvine, CA (US)

(72) Inventors: Edward Boyd, Petaluma, CA (US); Sanjay Goswami, Santa Rosa, CA (US)

(21) Appl. No.: 14/076,643

(22) Filed: Nov. 11, 2013

Related U.S. Application Data
(60) Provisional application No. 61/724,405, filed on Nov. 9, 2012.

(51) Int. Cl. H04Q 11/00

(52) U.S. Cl. CPC H04Q 11/0067
USPC 398/58

(57) ABSTRACT

Embodiments provide systems and methods for supporting the use of multiple downstream modulation profiles in an Ethernet Passive Optical Network over Coax (EPoC) network. This includes, at the Fiber Coax Unit (FCU), processing downstream traffic to determine its intended destination Coaxial Network Unit (CNU) and using a customized downstream modulation profile for the traffic based on its intended destination CNU. In addition, with the downstream modulation profile used for the downstream traffic varying in time, a downstream map indicating upcoming downstream modulation profiles in the downstream traffic is sent along with the downstream traffic from the FCU. A CNU can read the downstream map to determine upcoming downstream modulation profiles in the downstream traffic and can decide to decode a given transmitted modulation profile in the downstream traffic when the transmitted modulation profiles matches one or more downstream modulation profiles associated with the CNU.

### CROSS-REFERENCE TO RELATED APPLICATION(S)

The present application claims the benefit of U.S. Provisional Application No. 61/724,405, filed Nov. 9, 2012, which is incorporated herein by reference in its entirety.

### TECHNICAL FIELD

The present disclosure relates generally to Ethernet Passive Optical Network over Coax (EPoC), and more particularly to supporting multiple downstream modulation profiles.

### BACKGROUND

### Background Art

In an Ethernet Passive Optical Network over Coax (EPoC) network, Coaxial Network Units (CNUs) can be situated at different distances, and across varying numbers of intervening passive components (e.g., splitters, amplifiers, etc.), from a Fiber Coax Unit (FCU) that serves them. As a result, the CNUs can have different downstream bit carrying capacity profiles. Conventional solutions do not account for the different downstream bit carrying capacity profiles of CNUs, and, as a result, do not fully exploit the bit carrying capacity of the EPoC network.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates an example cable network architecture in which embodiments can be implemented or practiced.

FIG. 2 illustrates another example cable network architecture in which embodiments can be implemented or practiced.

FIG. 3 illustrates another example cable network architecture in which embodiments can be implemented or practiced.

FIG. 4 illustrates another example cable network architecture in which embodiments can be implemented or practiced.

FIG. 5 illustrates example downstream bit carrying capacity profiles for different coaxial network units (CNUs).

FIG. 6 illustrates an example Coaxial Line Terminal (CLT) according to an embodiment.

FIGS. 7A-7C illustrates various schemes for transmitting downstream map information from a CLT to a CNU.

FIG. 8 illustrates an example CNU according to an embodiment.

FIG. 9 illustrates an example process according to an embodiment.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

For purposes of this discussion, the term “module” shall be understood to include at least one of software, firmware, and hardware (such as one or more circuits, microchips, processors, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

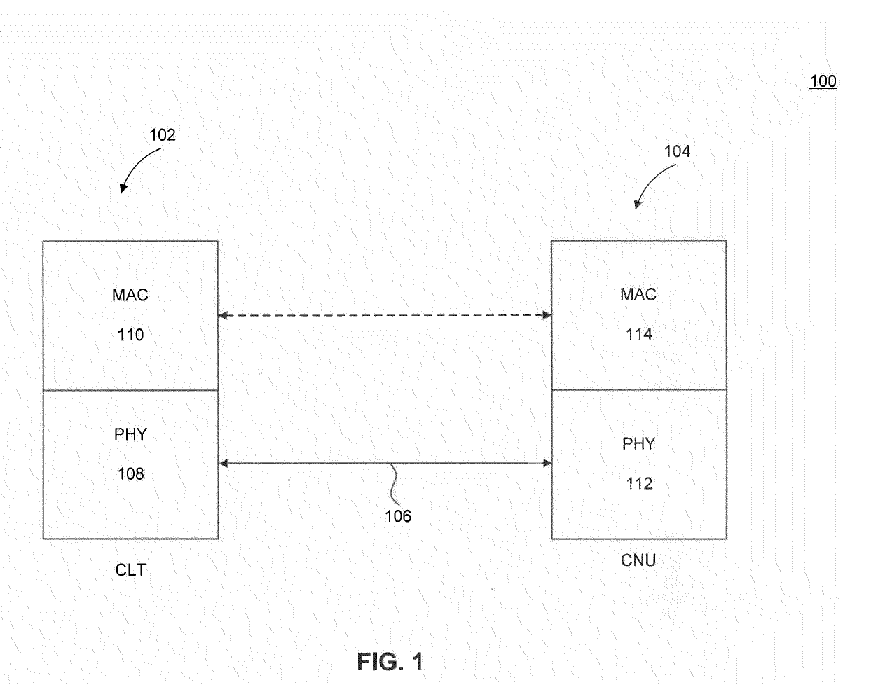

FIG. 1 illustrates an example cable network architecture 100 in which embodiments can be implemented or practiced. Example cable network architecture 100 is provided for the purpose of illustration only and is not limiting of embodiments.

As shown in FIG. 1, example network architecture 100 includes a CLT 102 and a CNU 104, coupled via a distribution network 106. Distribution network 106 can include a coaxial cable and optionally other coaxial components (e.g., splitters, amplifiers, etc.). As would be understood by a person of skill in the art based on the teachings herein, CLT 102 can serve multiple CNUs, such as CNU 104, in a point-to-multipoint topology.

CLT 102 and CNU 104 implement respective Medium Access Control (MAC) layers 110 and 114. In an embodiment, MAC layers 110 and 114 can be, without limitation, Ethernet Passive Optical Network (EPON) MAC layers. An end-to-end MAC link can be established between MAC layers 110 and 114 as shown in FIG. 1.

CLT 102 and CNU 104 implement physical layers (PHYs) 108 and 112 respectively. PHYs 108 and 112 establish a PHY link over distribution network 106, which can be transparent to upper layers such as the MAC layer. PHYs 108 and 112 can be, without limitation, Ethernet Passive Optical Network over Coax (EPoC) PHYs. In an embodiment, PHY 108 includes a service provider PHY and PHY 112 includes a subscriber PHY.

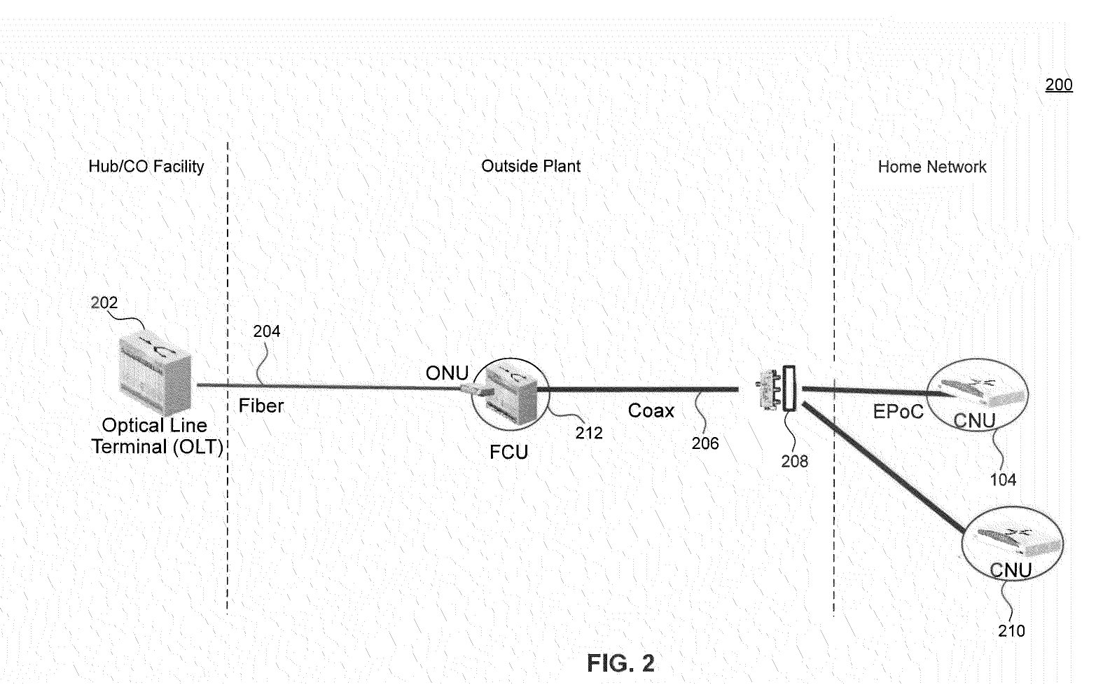

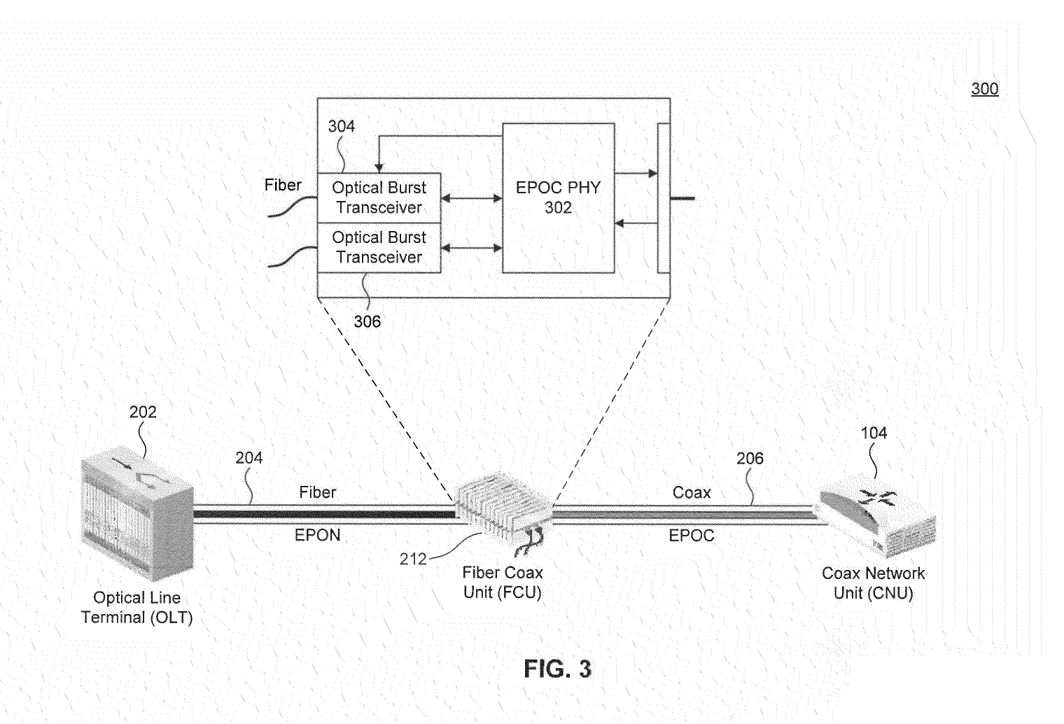

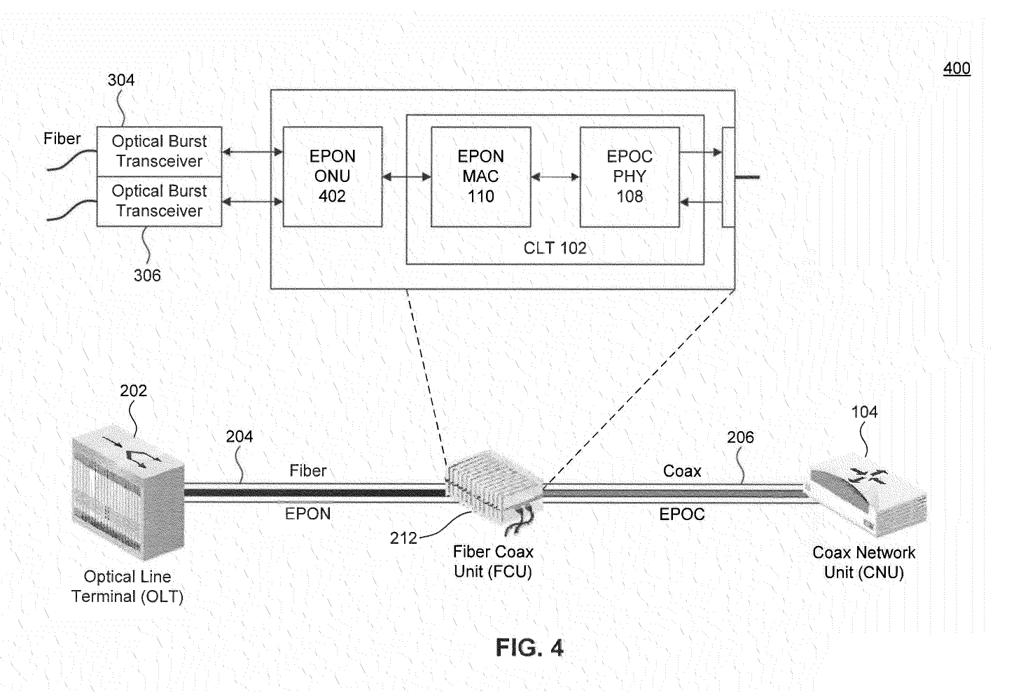

FIG. 2 illustrates another example cable network architecture 200 in which embodiments can be implemented or practiced. Example cable network architecture 200 is provided for the purpose of illustration only and is not limiting of embodiments. Cable network architecture 200 is a hybrid fiber coaxial (HFC) architecture. As shown in FIG. 2, example cable network architecture 200 includes an Optical Line Terminal (OLT) 202, which is coupled via a fiber optic line 204, to a Fiber Coax Unit (FCU) 212. FCU 212 is coupled via a coaxial cable 206, and an intervening splitter 208, to CNU 104 and a CNU 210. FCU 212 can have various configurations according to embodiments, two examples of which are described below with reference to FIGS. 3 and 4.

In example architecture 300 of FIG. 3, FCU 212 is in a managed repeater configuration and includes an EPoC PHY 302, an optical burst transceiver 304, and optical burst transceiver 306. FCU 212 can also include in this configuration an EPON MAC (not shown), which can be used for management. In this configuration, FCU 212 serves to convert at the PHY level between optical and coax. In an embodiment, FCU 212 includes a media converter for converting signals at the PHY level from optical to electrical, and vice versa. According to this configuration, an upstream transmission request from a CNU, such as CNU 104, is received by FCU 212, converted from coax to optical, and then transmitted to OLT 202. OLT 202 issues an EPON time grant in response to the request. The EPON time grant is converted from optical to coax at FCU 212 and then forwarded to CNU 104, which then transmits in the upstream in accordance with the EPON time grant. In the downstream, traffic from OLT 202 is converted from optical to coaxial by FCU 212 and then forwarded to its intended CNU destination (e.g., CNU 104).

In example architecture 400 of FIG. 4, FCU 212 is in a bridge configuration and includes a CLT 102 and an EPON ONU 402. CLT 102, as described above in FIG. 1, includes an EPON MAC 110 and an EPoC PHY 108. EPON ONU 402 includes an EPON MAC and is used to establish a MAC link between OLT 202 and FCU 212. In this configuration, the EPON time grant issuance to the CNUs occurs at FCU 212, particularly at EPON MAC 110. Specifically, an upstream transmission request from a CNU, such as CNU 104, is received by CLT 102 of FCU 212. EPON MAC 110 of CLT 102 issues an EPON time grant in response to the request, and the EPON time grant is sent to CNU 104. Subsequently, CNU 104 sends data in the upstream in accordance with the issued EPON time grant. The upstream data is received by EPON MAC 110 of CLT 102 and then forwarded to EPON ONU 402 of FCU 212. EPON ONU 402 can then request an upstream transmission request from OLT 202, in order to deliver this upstream data to OLT 202. In the downstream, data from OLT 202 is received and forwarded by EPON ONU 402 to CLT 102, which delivers the data to its intended CNU destination (e.g., CNU 104).

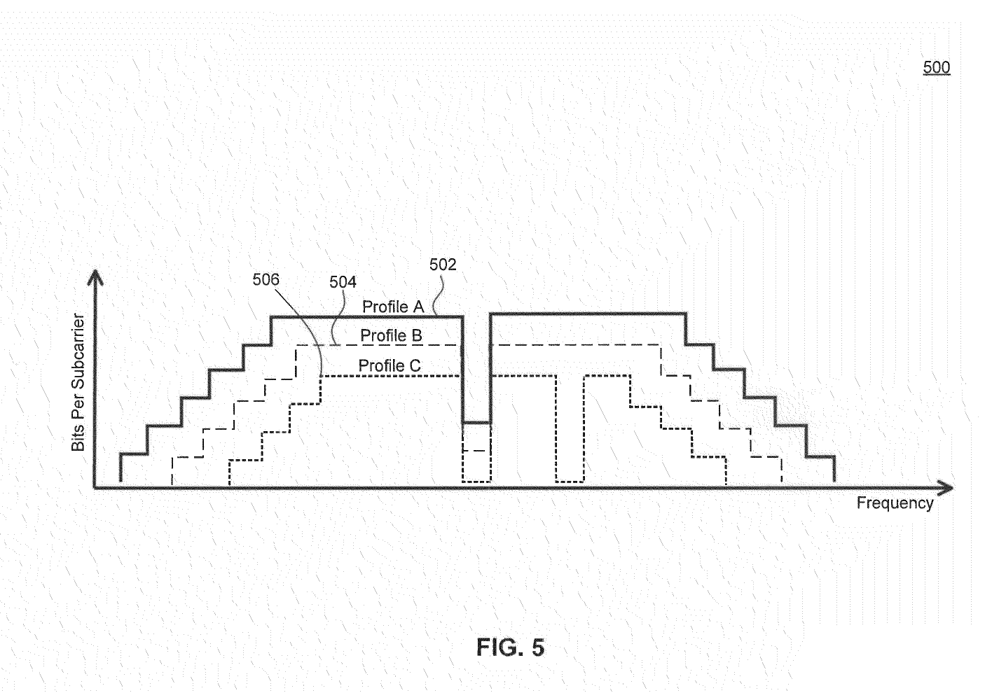

Returning to FIG. 2, CNUs 104 and 210 can be situated at different distances, and across varying numbers of intervening passive components (e.g., splitters, amplifiers, etc.), from FCU 212. For example, CNU 104 may be closer in distance or may have less intervening passive components between itself and FCU 212 than CNU 210. As a result, CNU 104 can have a better Signal to Noise Ratio (SNR) than CNU 210 and can accommodate higher symbol modulation orders (bits per symbol) per subcarriers (and thus a higher data rate) than CNU 210. CNUs 104 and 210 would thus have different downstream bit carrying capacity profiles as illustrated in FIG. 5 described below.

FIG. 5 is an example 500 that illustrates example downstream bit carrying capacity profiles for different coaxial network units (CNUs) in an example EPoC network. Example 500 is provided for the purpose of illustration only and is not limiting of embodiments. As shown in FIG. 5, example 500 includes three downstream bit carrying capacity profiles 502 (Profile A), 504 (Profile B), and 506 (Profile C), which may correspond respectively to three CNUs for example, here referred to as CNUs A, B, and C respectively. In other embodiments, profiles 502, 504, and 506 may each correspond to a group of CNUs.

The downstream bit carrying capacity profile of a CNU provides, for each subcarrier of the available frequency spectrum, the maximum number of bits that can be carried by the subcarrier in the downstream from the FCU to the CNU, such that the carried bits can be decoded at a desired performance level (e.g., symbol error rate) by the CNU.

In example 500, CNUs A, B, and C can be located at different distances, and across varying numbers of intervening passive components, from the FCU serving them. As such, as shown in FIG. 5, their respective downstream bit carrying capacity profiles 502, 504, and 506 can vary for the same frequency. For instance, in example 500, CNU A (having profile 502) has generally a greater bit carrying capacity across frequency than CNU B (having profile 504), which in turn has a greater bit carrying capacity across frequency than CNU C (having profile 506).

In addition, the bit carrying capacity per subcarrier can vary across frequency for the same CNU. For example, as shown in FIG. 5, profiles 502, 504, and 506 all have lower bit carrying capacity at the end frequencies of the available frequency spectrum. This may be due to roll off or interference from nearby located services. In addition, profiles 502, 504, and 506 may have nulled (notched) or attenuated subcarriers, in which no bits or a lower number of bits is transmitted to CNUs A, B, and C respectively. Nulling can be used to accommodate other existing services that operate within the nulled region of the frequency spectrum.

Conventional solutions do not account for the different downstream bit carrying capacity profiles of CNUs (or groups of CNUs) as illustrated in FIG. 5. Instead, the FCU is configured to accommodate a worst case downstream bit carrying capacity profile, for example that of the farthest CNU (or group of CNUs) from the FCU, by adopting a single common downstream modulation profile. The common downstream modulation profile provides, for each subcarrier of the available frequency spectrum, the number of bits that can be carried by the subcarrier (and optionally a corresponding modulation scheme to encode this maximum number of bits into the subcarrier). The single common downstream modulation profile is used regardless of the destination CNU (unicast) or group of CNUs (multicast) of the downstream traffic. While, in some cases, the FCU may also adopt a second common (lower modulation order) downstream modulation profile for broadcast traffic (traffic intended for reception by all CNUs), conventional solutions do not support downstream modulation profiles that are customized per the downstream bit carrying capacity profiles of the destination CNU (e.g., for unicast traffic) or groups of CNUs (e.g., for multicast traffic). As a result, the bit carrying capacity of the EPoC network is not fully exploited in the downstream.

Embodiments, as further described below, provide systems and methods for supporting the use of multiple downstream modulation profiles in an EPoC network. This includes, at the FCU, processing downstream traffic to determine its intended destination CNU (or group of CNUs) and using a customized downstream modulation profile for the traffic based on its intended destination CNU (or group of CNUs). In addition, with the downstream modulation profile used for the downstream traffic varying in time, a downstream map indicating upcoming downstream modulation profiles in the downstream traffic is sent along with the downstream traffic from the FCU. A CNU can read the downstream map to determine upcoming downstream modulation profiles in the downstream traffic and can decide to decode a given transmitted modulation profile in the downstream traffic when the transmitted modulation profiles matches one or more downstream modulation profiles associated with the CNU.

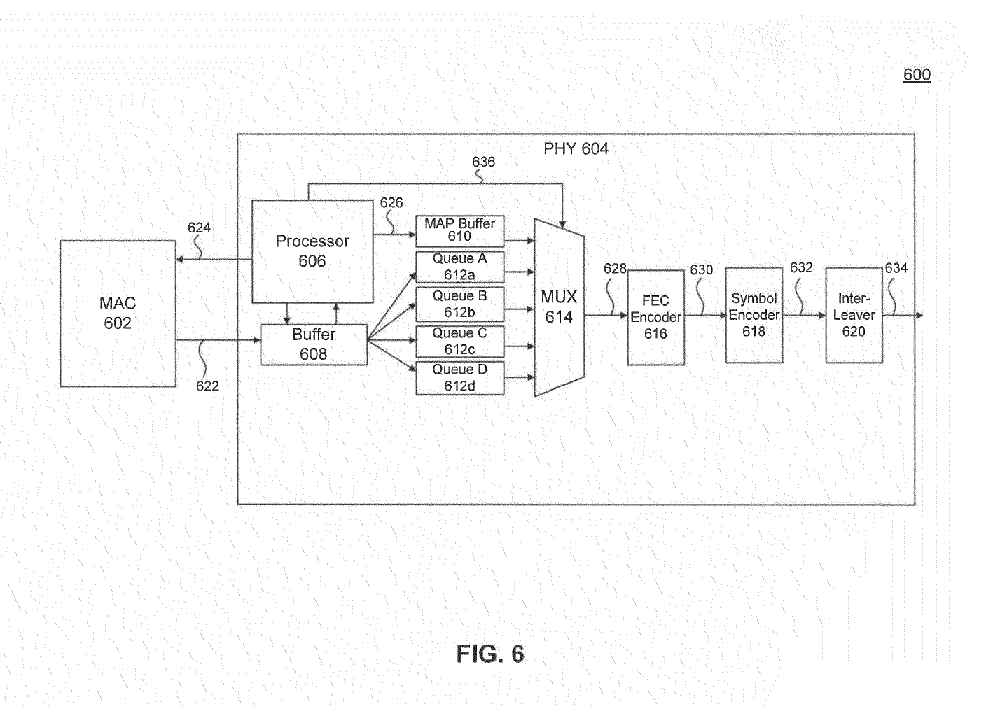

FIG. 6 illustrates an example CLT 600 according to an embodiment. Example CLT 600 is provided for the purpose of illustration only and is not limiting of embodiments. As shown in FIG. 6, example CLT 600 includes a MAC layer module 602 and a PHY module 604. Example CLT 600 can be an embodiment of CLT 102 shown in FIGS. 1 and 4, thereby allowing embodiments to be used in example architectures 100 or 400 described above. As such, MAC layer module 602 can be an embodiment of EPON MAC 110 and PHY module 604 can be an embodiment of EPoC PHY 108. PHY module 604 can be also be an embodiment of EPoC PHY 302 shown in FIG. 3, thereby allowing embodiments to be used within example architecture 300 described above.

In an embodiment, MAC layer module 602 is configured to generate a MAC stream 622 comprising a plurality of MAC frames and to provide MAC stream 622 to PHY module 604. The plurality of MAC frames can include unicast MAC frames, multicast MAC frames, and/or broadcast MAC frames. Typically, the destinations of consecutive MAC frames within MAC stream 622 alternate frequently over time for better Quality of Service (QoS). For example, a unicast MAC frame destined to a first CNU may be followed by a broadcast MAC frame, a multicast MAC frame destined to a group of CNUs, a unicast MAC frame to a second CNU, and then another unicast MAC frame destined to the first CNU.

In an embodiment, PHY module 604 includes, without limitation, a processor 606, a buffer 608, a MAP buffer 610, a plurality of queues 612a-d, a multiplexer 614, a Forward Error Correction (FEC) encoder 616, a symbol encoder 618, and an inter-leaver 620. In an embodiment, MAC stream 622 is received from MAC layer module 602 by buffer 608. In an embodiment, processor 606 associates a timestamp with each MAC frame of the plurality of MAC frames of MAC stream 622 when placed in buffer 608.

Subsequently, processor 606 accesses buffer 608 to process the plurality of MAC frames contained in MAC stream 622. In an embodiment, processor 606 processes each MAC frame of the plurality of frames to determine an identifier associated with the MAC frame. In an embodiment, MAC layer module 602 implements an EPON MAC layer, and the identifier determined by processor 606 is a Logical Link Identifier (LLID) assigned by the CLT to the destination CNU or the destination group of CNUs (multicast group or broadcast) of the MAC frame.

Based on the determined identifier, processor 606 queues (or instructs buffer 608 to queue) the MAC frame in a corresponding queue of the plurality of queues 612a-612d. In an embodiment, the plurality of queues 612a-612d are associated with a respective plurality of downstream modulation profiles. For example, queue 612a can be associated with a downstream modulation profile A, used for downstream transmission of broadcast traffic (traffic destined to all CNUs served by CLT 600). Queue 612b can be associated with a downstream modulation profile B, used for downstream transmission of multicast traffic to a first group of CNUs served by CLT 600. Similarly, queue 612c can be associated with a downstream modulation profile C, used for downstream transmission of multicast traffic to a second group of CNUs served by CLT 600. For example, the first or second group of CNUs can include a number of CNUs with comparable bit carrying capacity profiles, e.g., due to them being located within a same geographic region. Queue 612d can be associated with a downstream modulation profile D, used for downstream transmission of unicast traffic to a first CNU served by CLT 600.

As would be understood by a person of skill in the art, more or less than four queues can be used according to embodiments depending on the number of CNUs served by CLT 600 and/or the topology of the EPoC network. Further, according to embodiments, any given downstream modulation profile (e.g., A, B, C, or D) may be used for one or more traffic types. For example, downstream modulation profile B may be used, in addition to multicast traffic to the first group of CNUs, for downstream transmission to a second CNU served by the CLT 600. As such, the associated queue 612b may likewise be used to queue both the multicast traffic to the first group of CNUs and the unicast traffic to the second CNU.

In an embodiment, to determine the corresponding queue for the MAC frame being processed, processor 606 is configured to determine a downstream modulation profile from among the plurality of downstream modulation profiles based on the identifier. Processor 606 then queues the MAC frame into the corresponding queue based on the determined downstream modulation profile.

In an embodiment, downstream traffic from CLT 600 is transmitted in successive multi-subcarrier modulated frames, each including a plurality of multi-subcarrier modulated symbols. A given multi-subcarrier modulated frame occupies a plurality of frequency subcarriers over a plurality of successive symbol time intervals. Accordingly, in an embodiment, processor 606 is configured to dynamically calculate a fill level of each multi-subcarrier modulated frame scheduled for transmission. Once the fill level exceeds a predefined threshold, processor 606 sends a signal 624 to MAC layer module 602 to stop sending MAC stream 622 to PHY module 604, and stops processing MAC frames, if any, in buffer 608.

In an embodiment, the fill level of a scheduled multi-subcarrier modulated frame is updated as each MAC frame of MAC stream 622 is placed into a corresponding queue of the plurality of queues 612a-612d. For illustration, the computation of the fill level for the first received MAC frame is described below. The update of the fill level for subsequent MAC frames will be apparent to a person of skill in the art based on the teachings herein. For illustration, assume that the first MAC frame, after FEC encoding, is 20 bits long, that the first MAC frame will be mapped to the multi-subcarrier modulated frame starting with the lowest frequency subcarrier of the multi-subcarrier modulated frame, and that the multi-subcarrier modulated frame includes 10 symbols. Further assume for simplification that the downstream modulation profile associated the first MAC frame is limited to 2 bits per subcarrier for every subcarrier. Accordingly, the first MAC frame, after FEC encoding, would be mapped to occupy exactly the first subcarrier of the multi-subcarrier modulated frame. The fill level of the multi-subcarrier can thus be updated once the first MAC frame is queued to indicate that the first subcarrier of the multi-subcarrier modulated frame is full. As would be understood by a person of skill in the art based on the teachings herein, the multi-subcarrier modulated frame can be filled with MAC frames in different ways according to embodiments, for example starting from the highest frequency subcarrier or other subcarrier, skipping one or more subcarriers or symbols within a subcarrier (e.g., to insert control information such as the downstream map information), etc. The computation of the fill level of a scheduled multi-subcarrier modulated frame according to these variations would be similar to that described above as would be apparent to a person of skill in the art based on the teachings herein.

It is noted that because each given multi-subcarrier modulated frame may carry traffic to different destination CNUs (which means that different downstream modulation profiles may be used in each multi-subcarrier modulated), the total bits carried by successive multi-subcarrier modulated frames can vary.

Returning to FIG. 6, in an embodiment, once the fill level of a scheduled multi-subcarrier modulated frame exceeds the predefined threshold, processor 606 is configured to generate downstream map information 626, which describes the MAC frames scheduled to be placed in the scheduled multi-subcarrier modulated frame. In an embodiment, downstream map information 626 indicates the downstream modulation profile associated with each MAC frame scheduled to be carried by the multi-subcarrier modulated frame.

In an embodiment, processor 606 buffers downstream map information 626 in a MAP buffer 610. Processor 606 then controls multiplexer 614 using a control signal 636 to output the queued MAC frames in queues 612a-d onto an output stream 628. In an embodiment, the queued MAC frames in queues 612a-d are output onto output stream 628 in accordance with their respective timestamps added by processor 606. Processor 606 then controls multiplexer 614 to add downstream map information 626 to output stream 628. In other embodiments, downstream map information 626 is coupled to output stream 628 before the queued MAC frames or is interleaved with the MAC frames. In an embodiment, the order in which the MAC frames and the downstream map information are coupled to output stream 628 depends on the way that the downstream map information is carried in the multi-subcarrier modulated frame as further described below.

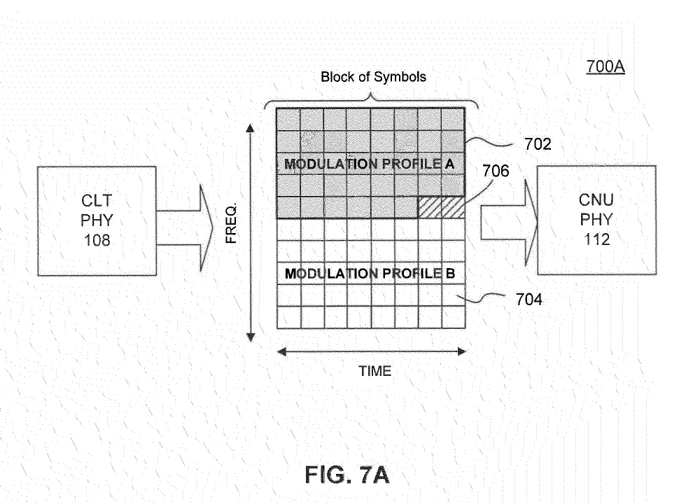

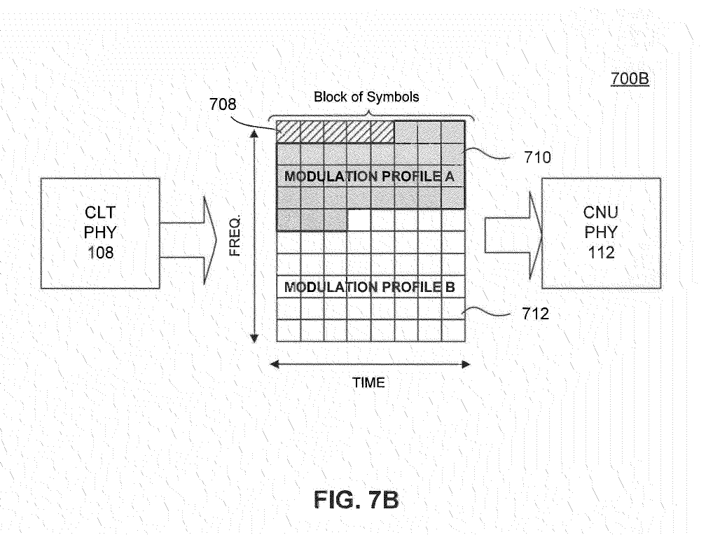

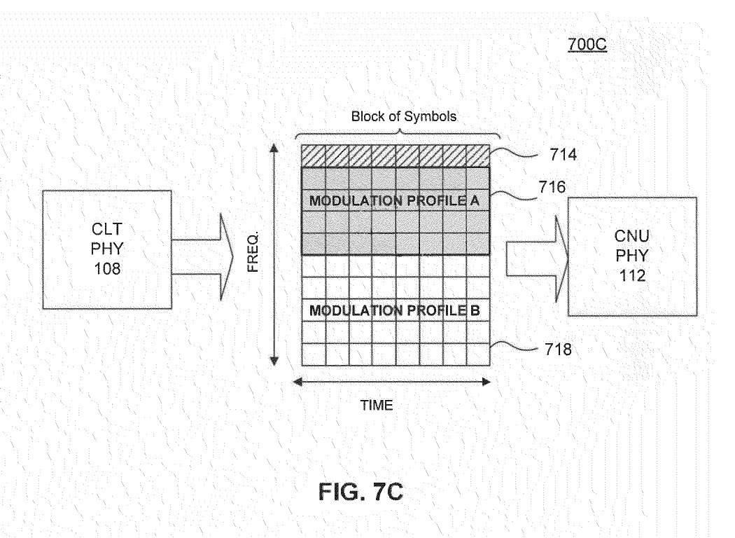

According to embodiments, downstream map information 626 can be carried in the multi-subcarrier modulated frame using different schemes as illustrated in FIGS. 7A, 7B, and 7C. In example implementation 700A of FIG. 7A, the downstream map information, illustrated by the numeral 706, includes a marker, which occupies a first symbol of the downstream map information, followed by a defined number of information symbols (one symbol shown in FIG. 7A). The marker can identify the end of MAC frame 702 or the start of MAC frame 704. The information symbols describe the downstream modulation profile (modulation profile B) of MAC frame 704 which follows downstream map information 706. As would be understood by a person of skill in the art based on the teachings herein, when consecutive MAC frames of the multi-subcarrier modulated frame have the same downstream modulation profile, they can be described by the same symbols of downstream map information 706. As such, the downstream map information is inserted into the multi-subcarrier frame to signal changes in the downstream modulation profiles within the multi-subcarrier frame. The downstream map information can also indicate to a receiver a size of a FEC block associated with a MAC frame within the multi-subcarrier modulated frame. For example, by reading two successive markers of the downstream map information, the receiver can determine the number of FEC encoded bits of the MAC frame transmitted between the two markers.

In example implementation 700B of FIG. 7B, the downstream map information, illustrated by the numeral 708, is inserted starting with the first subcarrier of the multi-subcarrier modulated frame. In the example of FIG. 7B, the downstream map information is shown to occupy 5 symbols of the first subcarrier. However, according to embodiments, the downstream map information may occupy more or less than 5 symbols and may even span more than one subcarrier. MAC frames 710 and 712 are then inserted back-to-back following downstream map information 708. In another embodiment, the downstream map information in inserted starting with the first symbol (which would be received first) of the multi-subcarrier modulated frame. In this implementation, the downstream map information describes for each following MAC frame (or consecutive MAC frames of same downstream modulation profile) the downstream modulation profile and a boundary of the MAC frame. For example, downstream map information 708 would describe the modulation profiles of MAC frames 710 and 712 as modulation profiles A and B respectively. The boundary of MAC frame 710 can be described as starting with symbol #6 of the first subcarrier and ending with symbol #3 of the fifth subcarrier.

In example implementation 700C, the downstream map information, illustrated by the numeral 714, occupies a fixed subset of subcarriers (the first subcarrier in the example of FIG. 7C) over all the symbols of the multi-subcarrier modulated frame for each frame. In this implementation, the downstream map information describes the downstream modulation profile and boundary of each MAC frame (or consecutive MAC frames with same downstream modulation profile) in the multi-subcarrier modulated frame. For example, downstream map information 714 would describe the modulation profiles of MAC frames 716 and 718 as modulation profiles A and B respectively. The boundary of MAC frame 716 can be described as starting with symbol #1 of the second subcarrier and ending with symbol #8 of the fifth subcarrier.

Returning to FIG. 6, output stream 628 of multiplexer 614 is forwarded to FEC encoder 616, where it is FEC encoded to generate FEC encoded blocks 630 corresponding respectively to the plurality of MAC frames and the downstream map information. Symbol encoder 618 then acts on FEC encoded blocks 630 to generate multi-carrier modulated symbols 632. Multi-carrier modulated symbols 632 can then be optionally inter-leaved by inter-leaver 620 to generate inter-leaved symbols 634, which can be transmitted after baseband and radio frequency (RF) processing.

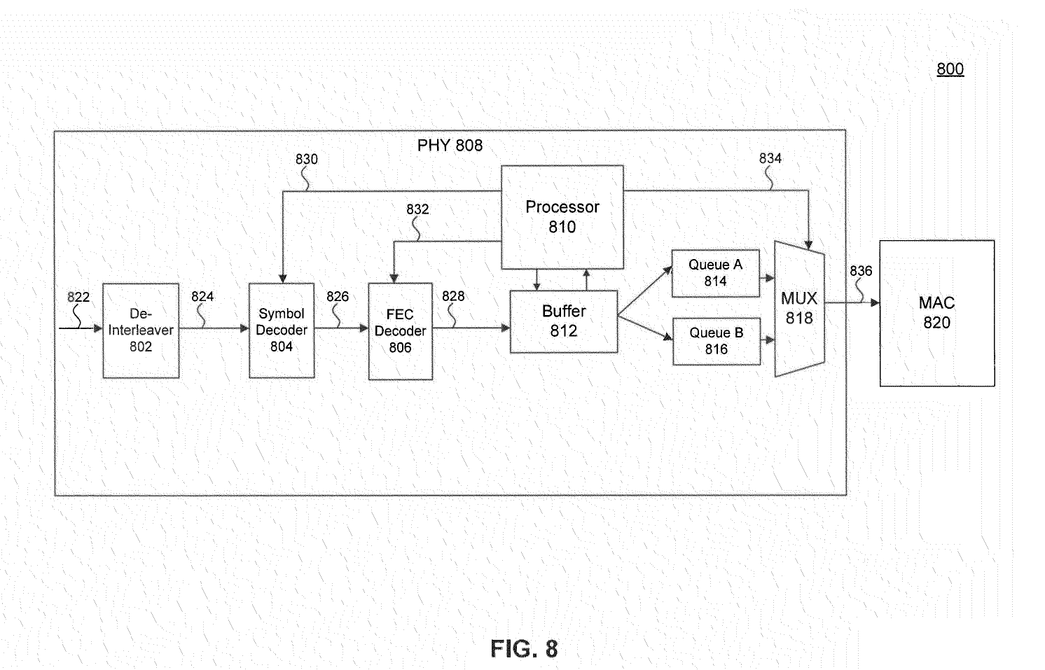

FIG. 8 illustrates an example CNU 800 according to an embodiment. Example CNU 800 is provided for the purpose of illustration only and is not limiting of embodiments. Example CNU 800 can be an embodiment of CNU 104 described above. As shown in FIG. 8, example CNU 800 includes a PHY module 808 and a MAC layer module 820. PHY module 808 includes, without limitation, a de-interleaver 802, a symbol decoder 804, an FEC decoder 806, a processor 810, a buffer 812, a plurality of queues 814 and 816, and a multiplexer 818. For the purpose of illustration, the operation of example CNU 800 is described with respect to the reception of a single multi-subcarrier modulated frame. The multi-subcarrier modulated frame can be generated and transmitted by a transmitter such as example CLT 600 or an FCU. As such, the multi-subcarrier modulated frame can contain one or more MAC frames, each associated with a respective downstream modulation profile, and downstream map information that describes the MAC frames contained in the multi-subcarrier modulated frame.

As shown in FIG. 8, in an embodiment, de-interleaver 802 is configured to receive an input signal 822 and to generate a de-interleaved input signal 824. De-interleaved input signal 824 is then acted upon by symbol decoder 804. For the purpose of illustration, it is assumed that de-interleaved input signal 824 corresponds to a single multi-subcarrier modulated frame transmitted by an FCU.

In an embodiment, symbol decoder 804 is configured to decode a first portion of a multi-subcarrier modulated frame to generate a first symbol decoded signal. In an embodiment, the first portion of the multi-subcarrier modulated frame corresponds to a portion of the frame carrying downstream map information. For example, the first portion can be a portion like 706 shown in FIG. 7A, 708 shown in FIG. 7B, or 714 shown in FIG. 7C. The first portion may also be composed of multiple disjoint portions, for example multiple portions like 706 shown in FIG. 7A separating multiple modulation profiles in the frame. In an embodiment, symbol decoder 804 decodes the first portion of the multi-subcarrier modulated frame according to a pre-determined downstream modulation profile associated with the downstream map information. The pre-determined downstream modulation profile can use a low order modulation scheme to ensure that the downstream modulation profile can be readily decoded by any CNU in the network.

Symbol decoder 804 provides the first symbol decoded signal in an output signal 826 to FEC decoder 806. FEC decoder 806 acts on output signal 826 to FEC decode the first symbol decoded signal and generate a first data block. FEC decoder 806 then provides the first data block in an output signal 828 to buffer 812. In an embodiment, the FEC decoder is configured to FEC decode the first symbol decoded signal according to a predetermined FEC block size associated with the downstream map information.

Processor 810 retrieves the first data block from buffer 812 and processes the first data block to determine the downstream map information. In an embodiment, the downstream map information indicates a boundary (time and frequency), a downstream modulation profile, and a FEC block size of a Medium Access Control (MAC) frame contained in the multi-subcarrier modulated frame. In another embodiment, the FEC block size is not directly indicated by the downstream map information but can be inferred from the boundary and downstream modulation profile.

Subsequently, processor 810 is configured to determine if the downstream modulation profile indicated by the downstream map information matches one or more profiles associated with CNU 800. For example, CNU 800 can be associated with a unicast downstream modulation profile (used by the FCU to transmit unicast traffic to CNU 800) and a broadcast downstream modulation profile (used by the FCU to broadcast to all served CNUs). CNU 800 may also be associated with one or more multicast downstream modulation profiles as part of one or more multicast groups.

If the downstream modulation profile indicated by the downstream map information matches at least one of the one or more profiles associated with CNU 800, then the MAC frame contained in the multi-subcarrier modulated frame is destined to CNU 800. Accordingly, in an embodiment, processor 810 signals the boundary and the downstream modulation profile (obtained from the downstream map information) to symbol decoder 804 via a control signal 830, and the FEC block size to FEC decoder 806 via a control signal 832.

Using the boundary and the downstream modulation profile, symbol decoder 804 decodes a second portion of the multi-subcarrier frame (corresponding to the MAC frame) to generate a second symbol decoded signal. Symbol decoder 804 provides the second symbol decoded signal in output signal 826 to FEC decoder 806, which FEC decodes the second symbol decoded signal to generate a second data block. The second data block includes the MAC frame. FEC decoder 806 provides the second data block in output signal 828 to buffer 812. Processor 810 then controls buffer 812 to forward the MAC frame, based on its associated downstream modulation profile, to a corresponding queue of the plurality of queues 814 and 816. For example, queues 814 and 816 may be associated with a unicast downstream modulation profile and a broadcast downstream modulation profile respectively. The MAC frame is forwarded to either of queues 814 and 816 depending on whether the MAC frame is a unicast or a broadcast frame.

The processing of the multi-subcarrier modulated frame may repeat as described above to process all MAC frames contained therein. In an embodiment, each processed MAC frame is queued into either of queues 814 and 816 and released to MAC layer module 820 according to a fixed delay relative to its associated timestamp added at the transmitter. For example, if a MAC frame had a timestamp equal to T at the transmitter, then the MAC frame is released to MAC layer module 820 at time T+D, where D represents the fixed delay. In an embodiment, the fixed delay is selected to accommodate a worst case delay jitter. According to this scheme, MAC frames are released to the MAC layer module 820 in accordance with the order in which they were generated by the MAC layer module at the transmitter. In an embodiment, processor 810 controls multiplexer 818 using a control signal 834 to selectively couple the outputs of queues 814 and 816 onto an output stream 836. Output stream 836 is transmitted over the MAC-PHY interface to MAC layer module 820.

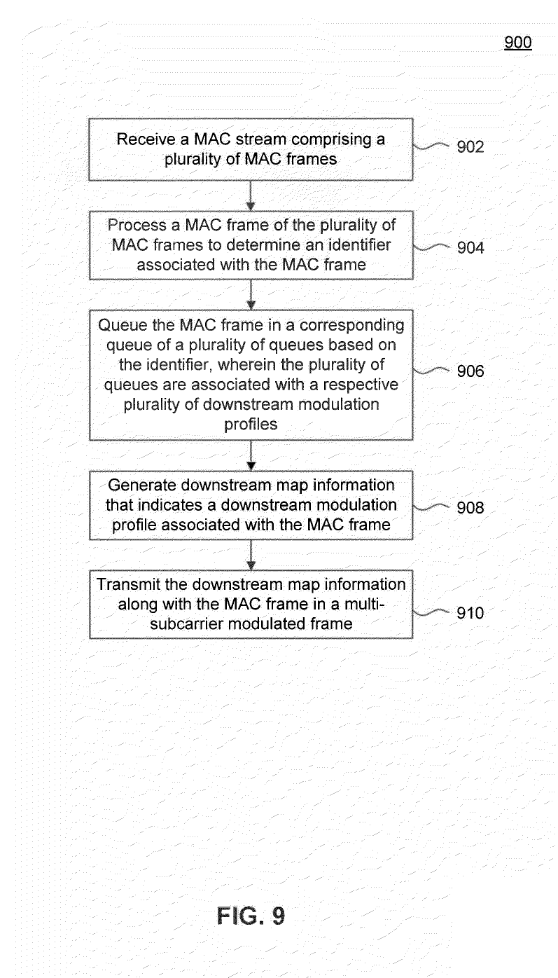

FIG. 9 illustrates an example process 900 according to an embodiment. Example process 900 is provided for the purpose of illustration only and is not limiting of embodiments. Example process 900 can be performed by an FCU, such as FCU 212 described, or a CLT, such as CLT 102 or 600 described above. In an embodiment, process 900 is performed by a PHY module, such as PHY module 604 described above in FIG. 6, which can be located within an FCU or CLT.

As shown in FIG. 9, process 900 begins in step 902, which includes receiving a MAC stream comprising a plurality of MAC frames. In an embodiment, the MAC stream is received from a MAC layer module.

In step 904, process 900 includes processing a MAC frame of the plurality of MAC frames to determine an identifier associated with the MAC frame. In an embodiment, the identifier is an LLID assigned to a destination CNU or a destination group of CNUs of the MAC frame.

Process 900 then proceeds to step 906, which includes queuing the MAC frame in a corresponding queue of a plurality of queues based on the identifier. In an embodiment, the plurality of queues are associated with a respective plurality of downstream modulation profiles. Accordingly, in an embodiment, step 906 further includes determining a downstream modulation profile from among the plurality of downstream modulation profiles based on the identifier, and queuing the MAC frame into the corresponding queue of the plurality of queues based on the determined downstream modulation profile.

Subsequently, in step 908, process 900 includes generating downstream map information that indicates the downstream modulation profile associated with the MAC frame. Process 900 terminates in step 910, which includes transmitting the downstream map information along with the MAC frame in a multi-subcarrier modulated frame comprising a plurality of multi-subcarrier modulated symbols. As described above with reference to FIGS. 7A, 7B, and 7C, the downstream map information can be transmitted along with the MAC frame according to different schemes.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments, as other embodiments will be apparent to a person of skill in the art based on the teachings herein.

What is claimed is:

1. A Coaxial Line Terminal (CLT), comprising:
a Medium Access Control (MAC) layer module configured to generate a MAC stream comprising a plurality of MAC frames; and
a physical layer (PHY) processor configured to receive the MAC stream from the MAC layer module, process a MAC frame of the plurality of MAC frames to determine an identifier associated with the MAC frame, and to queue the MAC frame in a corresponding queue of a plurality of queues based on the identifier.

2. The CLT of claim 1, wherein the plurality of MAC frames include one or more of: a unicast MAC frame, a multicast MAC frame, and a broadcast MAC frame.

3. The CLT of claim 1, wherein the MAC layer module implements an Ethernet Passive Optical Network (EPON) MAC layer, and wherein the identifier is a Logical Link Identifier (LLID) assigned by the CLT to a destination Coaxial Network Unit (CNU) or a destination group of CNUs of the MAC frame.

4. The CLT of claim 1, wherein the plurality of queues are associated with a respective plurality of downstream modulation profiles.

5. The CLT of claim 4, wherein the PHY processor is further configured to determine a downstream modulation profile from among the plurality of downstream modulation profiles based on the identifier, and to queue the MAC frame into the corresponding queue of the plurality of queues based on the determined downstream modulation profile.

6. The CLT of claim 1, wherein the PHY processor is further configured to associate a timestamp with the MAC frame when received from the MAC layer module.

7. The CLT of claim 6, wherein the PHY processor is further configured to output the MAC frame from the corresponding queue to an output stream in accordance with the timestamp associated with the MAC frame.

8. The CLT of claim 7, wherein the PHY processor is further configured to generate downstream map information, the downstream map information indicating a downstream modulation profile associated with the MAC frame, and to add the downstream map information to the output stream.

9. The CLT of claim 8, wherein the output stream is transmitted from the CLT as a multi-subcarrier modulated frame comprising a plurality of multi-subcarrier modulated symbols.

10. The CLT of claim 9, wherein the downstream map information includes a marker that identifies at least one of a start and an end of the MAC frame within the multi-sub-carrier modulated frame.

11. The CLT of claim 9, wherein the downstream map information further indicates a size of a Forward Error Correction (FEC) block associated with the MAC frame within the multi-subcarrier modulated frame.

12. The CLT of claim 9, wherein the downstream map information occupies a fixed subset of subcarriers over all of the plurality of multi-subcarrier modulated symbols of the multi-subcarrier modulated frame.

13. A method, comprising:
receiving a Medium Access Control (MAC) stream comprising a plurality of MAC frames;
processing a MAC frame of the plurality of MAC frames to determine an identifier associated with the MAC frame; and
queuing the MAC frame in a corresponding queue of a plurality of queues based on the identifier.

14. The method of claim 13, wherein the identifier is a Logical Link Identifier (LLID) assigned to a destination Coaxial Network Unit (CNU) or a destination group of CNUs of the MAC frame.

15. The method of claim 13, wherein the plurality of queues are associated with a respective plurality of downstream modulation profiles.

16. The method of claim 15, further comprising:
determining a downstream modulation profile from among the plurality of downstream modulation profiles based on the identifier, and
queuing the MAC frame into the corresponding queue of the plurality of queues based on the determined downstream modulation profile.

17. The method of claim 15, further comprising:
generating downstream map information, the downstream map information indicating a downstream modulation profile associated with the MAC frame; and
transmitting the downstream map information along with the MAC frame in a multi-subcarrier modulated frame comprising a plurality of multi-subcarrier modulated symbols.

18. A Coaxial Network Unit (CNU), comprising:
a symbol decoder configured to decode a first portion of a multi-subcarrier modulated frame to generate a first symbol decoded signal;
a Forward Error Correction (FEC) decoder configured to FEC decode the first symbol decoded signal to generate a first data block; and
a physical layer (PHY) processor configured to process the first data block to determine downstream map information, the downstream map information indicating a boundary, a downstream modulation profile, and a FEC block size of a Medium Access Control (MAC) frame contained in the multi-subcarrier modulated frame.

19. The CNU of claim 18, wherein the symbol decoder is further configured to decode the first portion of the multi-subcarrier modulated frame according to a pre-determined downstream modulation profile associated with the downstream map information, and wherein the FEC decoder is further configured to FEC decode the first symbol decoded signal according to a predetermined FEC block size associated with the downstream map information.

20. The CNU of claim 18, wherein the processor is further configured to:
determine if the downstream modulation profile indicated by the downstream map information matches one or more profiles associated with the CNU;
if the downstream modulation profile matches at least one of the one or more profiles associated with the CNU, signal the boundary and the downstream modulation profile to the symbol decoder and the FEC block size to the FEC decoder.

21. The CNU of claim 20, wherein the symbol decoder is further configured to decode a second portion of the multi-subcarrier modulated frame, according to the boundary and the downstream modulation profile, to generate a second symbol decoded signal, and wherein the FEC decoder is further configured to FEC decode the second symbol decoded signal to generate a second data block.

22. The CNU of claim 21, wherein the second data block includes the MAC frame, and wherein the processor is further configured to forward the MAC frame, based on the downstream modulation profile, to a corresponding queue from a plurality of queues, the plurality of queues associated with a respective plurality of downstream modulation profiles.
